(19) United States
(12) Patent Application Publication
(10) Pub. No.: US 2009/0186762 A1
(43) Pub. Date: Jul. 23, 2009

(54) METHOD FOR IMPROVING THE TOLERANCE OF PLANTS TO CHILLING TEMPERATURES AND/OR FROST

(75) Inventors: Wilhelm Rademacher, Limburgerhof (DE); Harald Köhle, Bobenheim (DE); Vince Ulstad, Fargo, ND (US)

Correspondence Address: BIRCH STEWART KOLASCH & BIRCH, PO BOX 747, FALLS CHURCH, VA, 22040-0747, US

(73) Assignee: BASF SE, Ludwigshafen (DE)

(21) Appl. No.: 12/281,926

(22) PCT Filed: Mar. 2, 2007
(86) PCT No.: PCT/EP2007/051996

§ 371 Date: Jan. 16, 2009

Related U.S. Application Data
(60) Provisional application No. 60/781,022, filed on Mar. 10, 2006.
(60) Provisional application No. 60/830,981, filed on Jul. 14, 2006.

(51) Int. Cl. A01N 43/54; A01N 43/56; A01P 21/00

(52) U.S. Cl. 504/136; 504/282; 504/243; 504/139

(57) ABSTRACT

The present invention relates to the use of an active compound that inhibits the mitochondrial breathing chain at the level of the b/c₁ complex for improving the tolerance of plants to low temperatures.

The present invention relates to the use of compounds that inhibit the mitochondrial breathing chain at the level of the b/c₁ complex, in particular of active strobilurin compounds, for improving the tolerance of plants to chilling temperatures and/or frost.

Temperature is one of the main factors, which affect the growth of plants. Chilling temperatures (of down to 0° C.) and frost (temperatures of below 0° C.) may slow down germination and plant growth and have a substantial effect on their development and on the quantity and quality of their products. Crop plants such as corn, sugar beet, rice, soybean, potato, tomato, bell pepper, melon, cucumber, bean, pea, banana and citrus species suffer injury and/or substantially delayed development even at temperatures of below 5° C. Even temperatures which are slightly below 0° C. lead to partial or complete death of these plant species. Late frosts around the time of flowering, for example, repeatedly lead to substantial yield losses for example in pome and stone fruit species such as apple, pear, quince, peach, nectarine, apricot, plum, damson, almond or cherry. Plants, which have suffered chilling injury or frost damage, show dieback symptoms, for example on leaves, flowers and buds. Frost-damaged flowers develop no fruit at all or else deformed fruit or fruit with skin damage, which can only be sold with difficulty, if at all. Severe chilling injury and frost damage entails the death of the entire plant.

Chilling injury and frost damage are therefore important loss factors for the agricultural sector. Existing possibilities for avoiding chilling injury and frost damage are rather unsatisfactory owing to their complexity or the fact that the results are frequently not reproducible. Possibilities which must be mentioned in this context are the breeding of chill- and frost-resistant plant varieties, starting off chill-sensitive plants in the greenhouse and subsequently planting them out as late as possible, cultivation under plastic film, circulation of air in the stand, blowing in warm air, placing heaters in the stand, and irrigation frost protection.

DE 4437945 describes plant-strengthening products comprising vitamin E, which are said to reduce the plant-injurious effect of phytotoxic agrochemicals and other abiotic stressors. These compositions may additionally comprise cryoprotectants such as glycerol. The cryoprotectant, which is optionally present, is not described as having an effect, which prevents chilling injury or frost damage.

J. Lalk and K. Dörffling describe in Physiol. Plant. 63, 287-292 (1985) that abscisic acid can improve the frost resistance to chilling temperatures in hardened winter wheat.

It was an object of the present invention to provide a composition, which improves the tolerance of plants to chilling temperatures and/or frost.

This object has been achieved by using an active compound that inhibits the mitochondrial breathing chain at the level of the b/c₁ complex for improving the tolerance of plants to low temperatures. In particular, strobilurins are useful for the purpose of the present invention.

Active compounds that inhibit the mitochondrial breathing chain at the level of the b/c₁ complex are known as fungicides from the literature [see for example Dechema-Monographien Bd. 129, 27-38, VCH Verlagsgemeinschaft Weinheim 1993; Natural Product Reports 1993, 565-574; Biochem. Soc. Trans. 22, 63S (1993)]. However, there has been no suggestion to date that such active compounds can effectively be used for improving the tolerance of plants to chilling temperatures and/or frost, which has only been found within the framework of the present invention.

A particularly important class of active compounds that inhibit the mitochondrial breathing chain at the level of the b/c₁ complex are strobilurins. Strobilurins are generally known as fungicides since a long time and have, in some cases, also been described as insecticides (EP-A 178 826; EP-A 253 213; WO 93/15046; WO 95/18789; WO 95121153; WO 95121154; WO 95124396; WO 96/01256; WO 97/15552; WO 97/27189). A further example of an active compound that inhibits the mitochondrial breathing chain at the level of the b/c₁ complex is famoxadone (5-methyl-5-(4-phenoxyphenyl)-3-(phenylamino)-2,4-oxazolidinedione).

Specific examples for suitable strobilurins are compounds of formula I

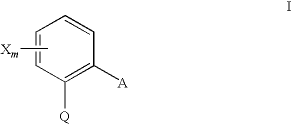

in which the variables are as defined below:
X is halogen, C₁-C₄-alkyl or trifluoromethyl;
m is 0 or 1;
Q is C(═CH—CH₃)—COOCH₃, C(═CH—OCH₃)—COOCH₃, C(═N—OCH₃)—CONHCH₃, C(═N—OCH₃)—COOCH₃, N(—OCH₃)—COOCH₃, or the group Q1

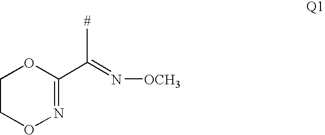

where # denotes the bond to the phenyl ring;
A is —O—B, —CH₂O—B, —OCH₂—B, —CH₂S—B, —CH═CH—B, —C≡C—B, —CH₂O—N═C(R¹)—B, —CH₂S—N═C(R¹)—B, —CH₂O—N═C(R¹)—CH═CH—B, or —CH₂O—N═C(R¹)—C(R²)═N—OR³, where
B is phenyl, naphthyl, 5- or 6-membered heteroaryl or 5- or 6-membered hetero-cyclyl which contains one, two or three nitrogen atoms and/or one oxygen or sulfur atom or one or two oxygen and/or sulfur atoms, where the ring systems are unsubstituted or substituted by one, two or three groups R^{a}:
   R^{a} independently of one another are cyano, nitro, amino, aminocarbonyl, aminothiocarbonyl, halogen, C₁-C₆-alkyl, C₁-C₆-haloalkyl, C₁-C₆-alkyl-carbonyl, C₁-C₆-alkylsulfonyl, C₁-C₆-alkylsulfinyl, C₃-C₆-cycloalkyl, C₁-C₆-alkoxy, C₁-C₆-haloalkoxy, C₁-C₆-alkyloxycarbonyl, C₁-C₆-alkyl-thio, C₁-C₆-alkylamino, di-C₁-C₆-alkylamino, C₁-C₆-alkylamino-carbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy, phenyl, phenoxy, benzyl, benzyloxy, 5- or 6-membered heterocyclyl, 5- or 6-membered heteroaryl, 5- or 6-membered heteroaryloxy, C(═NOR^{a})—R^{b} or OC(R^{a})₂—C(R^{b})═NOR^{b}, where the cyclic groups for their part may be unsubstituted or substituted by one, two, three, four or five groups R^{b}:
   R^{b} independently of one another are cyano, nitro, halogen, amino, aminocarbonyl, aminothiocarbonyl, C₁-C₆-alkyl, C₁-C₆-haloalkyl, C₁-C₆-alkylsulfonyl, C₁-C₆-alkylsufinyl, C₃-C₆-cycloalkyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy, C₃-C₆-cycloalkyl, C₁-C₆-cycloalkenyl, phenyl, phenoxy, phenylthio, benzyl, benzyloxy, 5- or 6-membered heterocyclyl, 5- or 6-membered heteroaryl, 5- or 6-membered heteroaryloxy or C(═NOR^{A})—R^{B};
   R^{A}, R^{B} independently of one another are hydrogen or C₁-C₆-alkyl;
   R¹ is hydrogen, cyano, C₁-C₄-alkyl, C₁-C₄-haloalkyl, C₃-C₆-cycloalkyl, C₁-C₄-alkoxy, or C₁-C₄-alkylthio;
   R² is phenyl, phenylcarbonyl, phenylsulfonyl, 5- or 6-membered heteroaryl, 5- or 6-membered heteroarylcarbonyl or 5- or 6-membered heteroarylsulfonyl, where the ring systems may be unsubstituted or substituted by one, two, three, four or five groups R^{a},
   C₁-C₁₀-alkyl, C₃-C₆-cycloalkyl, C₂-C₁₀-alkenyl, C₂-C₁₀-alkynyl, C₁-C₁₀-alkylcarbonyl, C₂-C₁₀-alkenylcarbonyl, C₃-C₁₀-alkynylcarbonyl, C₁-C₁₀-alkylsulfonyl or C(═NOR^{a})—R^{b}, where the carbon chains may be unsubstituted or substituted by one, two, three, four or five groups R^{c}:
      R^{c} independently of one another are cyano, nitro, amino, amino-carbonyl, aminothiocarbonyl, halogen, C₁-C₆-alkyl, C₁-C₆-haloalkyl, C₁-C₆-alkylsulfonyl, C₁-C₆-alkylsulfinyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkylaminothiocarbonyl, di-C₁-C₆-alkylaminothiocarbonyl, C₂-C₆-alkenyl, C₂-C₆-alkenyloxy,
      C₃-C₆-cycloalkyl, C₃-C₆-cycloalkyloxy, 5- or 6-membered heterocyclyl, 5- or 6-membered heterocyclyloxy, benzyl, benzyloxy, phenyl, phenoxy, phenylthio, 5- or 6-membered heteroaryl, 5- or 6-membered heteroaryloxy or heteroarylthio, where the cyclic groups may be partially or fully halogenated or may be substituted by one, two or three groups R^{a}; and
R³ is hydrogen, C₁-C₆-alkyl, C₂-C₆-alkenyl, C₂-C₆-alkynyl, where the carbon chains may be partially or fully halogenated or may be substituted by one, two, three, four or five groups R^{c}; and
   strobilurin compounds selected from the group consisting of methyl (2-chloro-5-[1-(3-methylbenzyloxyimino) ethyl]benzyl)carbamate, methyl (2-chloro-5-[1-(6-methylpyridin-2-ylmethoxyimino)ethyl]benzyl)carbamate, 2-(2-(6-(3-chloro-2-methyl-phenoxy)-5-fluoro-pyrimidin-4-yloxy)-phenyl)-2-methoxy-imino-N-methyl-acetamide and 3-methoxy-2-(2-(N-(4-methoxy-phenyl)cyclo-propane-carboximidoyl-sulfanyl-methyl)-phenyl)-acrylic acid methyl ester;
   and salts thereof.

The active compounds of formula I belong to the class of the active strobilurin compounds which have been known for a long time to be active as fungicides and, in individual cases, also as insecticides. They are described, inter alia, in EP 178 826; EP 253 213; WO 93115046; WO 95/18789; WO 95/21153; WO 95/21154; WO 95/24396; WO 96/01256; WO 97/15552; WO 97/27189.

According to the present invention, the cold stress that plants may undergo if a decrease in temperature occurs, can be prevented or effectively reduced with the present invention.

In crop production, low temperatures are understood as meaning chilling temperatures and frost, i.e. temperatures of 15° C., preferably in the range of from 15° C. to −15° C., especially preferably of from 10° C. to −10° C. and in particular of from 10° C. to −5° C. Also temperature ranges of from 10° C. or 11° C. to 0° C. and 5° C. to 0° C. as well as temperature ranges of below 0° C. can be damaging to the respective crop. Thereby, the temperature that leads to damages of plants may also depend on the crop concerned.

The compounds which are used in accordance with the invention are preferably employed for improving the tolerance of plants to a temperature range of from −15° C. to 15° C., especially preferably of from −10° C. to 10° C. and in particular of from −5° C. to 10° C. Furthermore, the improvement of the tolerance of plants to temperature ranges of from 10° C. or 11° C. to 0° C., 5° C. to 0° C. as well as temperature ranges of below 0° C. is specifically important.

In the case of chill-sensitive plants, the compounds used according to the present invention, particularly a strobilurin compound, more specifically the compounds of formula I, are employed in particular for improving the tolerance of the plants to chilling temperatures and to reduce the cold stress of plants in case of a decrease in temperature, respectively. This is generally understood as meaning a tolerance to temperatures in the range of from 0° C. to 15° C., in particular of from 0° to 10° C. In the case of frost-sensitive plants—in addition to the abovementioned chill-sensitive plants, these are, for example, pome and stone fruit species during the flowering phase and citrus species and other plants which, while chill-resistant, are not frost-resistant—these compounds are in particular also suitable for improving the tolerance of the plants to temperatures in the range of from −15° C. to 0° C., especially preferably of from −10° C. to 0° C., and in particular of from −5° C. to 0° C.

Tolerance is understood as meaning in particular the reduction or prevention of chilling injury and/or frost damage in plants.

According to the present invention, cold stress is not restricted to frost damage by formation of ice crystals, but damages can also happen at higher temperatures than mentioned above, especially in sensitive crops. For such plants, already temperatures of for example 10° C. to 5° C. or 10° C. to 0° C. can result in significant damages. According to the present invention, it has been found that it is also possible to prevent sensitive crops from such damages by applying a compound that inhibits the mitochondrial breathing chain at the level of the b/c, complex, particularly a compound of formula I. In this manner, for example coffee, corn, rice soybean and citrus fruits species can be effectively protected against cold stress.

The compounds that inhibit the mitochondrial breathing chain at the level of the b/c, complex, particularly strobilurins, more specifically the compounds of formula I, are especially preferably used for reducing or preventing chilling injury in chill-sensitive crop plants such as corn, rice, soybean, sugar beet, sugar cane, aubergine, tomato, bell pepper, potato, melon, cucumber, grapevines (grapes), bean, pea, banana, citrus species and coffee. Furthermore, the present invention can be successfully applied against cold stress to wheat, barley, sunflower and rapeseed.

Moreover, according to the invention, the compounds that inhibit the mitochondrial breathing chain at the level of the b/c, complex, in particular the compounds of formula I, are especially preferably used for reducing or preventing frost damage in the above mentioned chill-sensitive crop plants, moreover in pome fruit and stone fruit, in all citrus species and coffee. In the case of the pome fruit and stone fruit species, these compounds are especially preferably used for preventing frost damage on the buds, flowers, leaves and young fruits of these plants. The pome fruit and stone fruit species are, for example, apple, pear, quince, peach, apricot, nectarine, cherry, plum, damson or almond, preferably apple. The citrus species are, for example, lemon, orange, grapefruit, clementine or tangerine.

In particular, the compounds used according to the present invention, specifically the compounds of formula I, are used for reducing or preventing frost damage in stone fruit species (e.g. almond) and pome fruit, in particular in apple.

One embodiment of the invention relates to the use of an active compound of formula I as defined in the outset or a strobilurin compound selected from methyl (2-chloro-5-[1-(3-methylbenzyloxyimino)ethyl]benzyl)carbamate and methyl (2-chloro-5-[1-(6-methylpyridin-2-ylmethoxyamino)ethyl]benzyl)carbamate.

In another embodiment of the invention compounds of formula I as defined in the outset are used.

In addition, following compounds as listed in the tables below may be used according to the invention.

TABLE I

| | |
|---|---|
| | II |
| 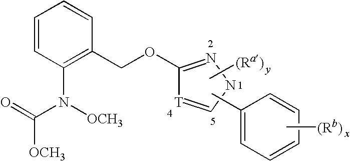 | |

| | | | Position of the group | | |
|---|---|---|---|---|---|
| No. | T | (R^{a′})_{y} | phenyl-(R^{b})ₓ | (R^{b})ₓ | Reference |
| I-1 | N | — | 1 | 2,4-Cl₂ | WO 96/01256 |
| I-2 | N | — | 1 | 4-Cl | WO 96/01256 |
| I-3 | CH | — | 1 | 2-Cl | WO 96/01256 |
| I-4 | CH | — | 1 | 3-Cl | WO 96/01256 |
| I-5 | CH | — | 1 | 4-Cl | WO 96/01256 |
| I-6 | CH | — | 1 | 4-CH₃ | WO 96/01256 |
| I-7 | CH | — | 1 | H | WO 96/01256 |
| I-8 | CH | — | 1 | 3-CH₃ | WO 96/01256 |
| I-9 | CH | 5-CH₃ | 1 | 3-CF₃ | WO 96/01256 |
| I-10 | CH | 1-CH₃ | 5 | 3-CF₃ | WO 99/33812 |
| I-11 | CH | 1-CH₃ | 5 | 4-Cl | WO 99/33812 |
| I-12 | CH | 1-CH₃ | 5 | — | WO 99/33812 |

TABLE II

| | |
|---|---|
| | III |
| 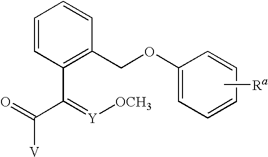 | |

| No. | V | Y | R^{a} | Reference |
|---|---|---|---|---|
| II-1 | OCH₃ | N | 2-CH₃ | EP-A |
| | | | | 253 213 |
| II-2 | OCH₃ | N | 2,5-(CH₃)₂ | EP-A |
| | | | | 253 213 |
| II-3 | NHCH₃ | N | 2,5-(CH₃)₂ | EP-A |
| | | | | 477 631 |
| II-4 | NHCH₃ | N | 2-Cl | EP-A |
| | | | | 398 692 |
| II-5 | NHCH₃ | N | 2-CH₃ | EP-A |
| | | | | 398 692 |
| II-6 | NHCH₃ | N | 2-CH₃, 4-OCF₃ | EP-A |
| | | | | 628 540 |
| II-7 | NHCH₃ | N | 2-Cl, 4-OCF₃ | EP-A |
| | | | | 628 540 |
| II-8 | NHCH₃ | N | 2-CH₃, 4- | EP-A |
| | | | OCH(CH₃)—C(CH₃)═NOCH₃ | 11 18 609 |
| II-9 | NHCH₃ | N | 2-Cl, 4- | EP-A |
| | | | OCH(CH₃)—C(CH₃)═NOCH₃ | 11 18 609 |
| II-10 | NHCH₃ | N | 2-CH₃, 4- | EP-A |
| | | | OCH(CH₃)—C(CH₂CH₃)═NOCH₃ | 11 18 609 |
| II-11 | OCH₃ | CH | 2,5-(CH₃)₂ | EP-A |
| | | | | 226 917 |

TABLE III

| | |
|---|---|
| | IV |
| 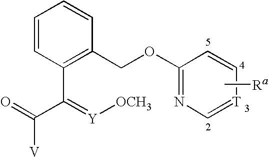 | |

| No. | V | Y | T | R^{a} | Reference |
|---|---|---|---|---|---|
| III-1 | OCH₃ | CH | N | 2-OCH₃, 4-CF₃ | WO 96/16047 |
| III-2 | OCH₃ | CH | N | 2-OCH(CH₃)₂, 4-CF₃ | WO 96/16047 |
| III-3 | OCH₃ | CH | CH | 2-CF₃ | EP-A 278 595 |
| III-4 | OCH₃ | CH | CH | 4-CF₃ | EP-A 278 595 |
| III-5 | NHCH₃ | N | CH | 2-Cl | EP-A 398 692 |
| III-6 | NHCH₃ | N | CH | 2-CF₃ | EP-A 398 692 |
| III-7 | NHCH₃ | N | CH | 2-CF₃, 4-Cl | EP-A 398 692 |
| III-8 | NHCH₃ | N | CH | 2-Cl, 4-CF₃ | EP-A 398 692 |

TABLE IV

| | |
|---|---|
| | V |
| 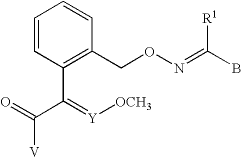 | |

| No. | V | Y | R¹ | B | Reference |
|---|---|---|---|---|---|
| IV-1 | OCH₃ | CH | CH₃ | (3-CF₃)C₆H₄ | EP-A 370 629 |
| IV-2 | OCH₃ | CH | CH₃ | (3,5-Cl₂)C₆H₃ | EP-A 370 629 |
| IV-3 | NHCH₃ | N | CH₃ | (3-CF₃)C₆H₄ | WO 92/13830 |
| IV-4 | NHCH₃ | N | CH₃ | (3-OCF₃)C₆H₄ | WO 92/13830 |
| IV-5 | OCH₃ | N | CH₃ | (3-OCF₃)C₆H₄ | EP-A 460 575 |
| IV-6 | OCH₃ | N | CH₃ | (3-CF₃)C₆H₄ | EP-A 460 575 |
| IV-7 | OCH₃ | N | CH₃ | (3,4-Cl₂)C₆H₃ | EP-A 460 575 |
| IV-8 | OCH₃ | N | CH₃ | (3,5-Cl₂)C₆H₃ | EP-A 463 488 |
| IV-9 | OCH₃ | CH | CH₃ | CH═CH-(4-Cl)C₆H₄ | EP-A 936 213 |

TABLE V

| | |
|---|---|
| | VI |
| 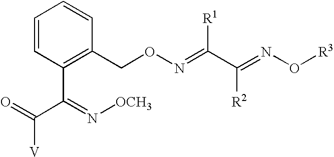 | |

| No. | V | R¹ | R² | R³ | Reference |
|---|---|---|---|---|---|
| V-1 | OCH₃ | CH₃ | CH₃ | CH₃ | WO |
| | | | | | 95/18789 |
| V-2 | OCH₃ | CH₃ | CH(CH₃)₂ | CH₃ | WO |
| | | | | | 95/18789 |
| V-3 | OCH₃ | CH₃ | CH₂CH₃ | CH₃ | WO |
| | | | | | 95/18789 |
| V-4 | NHCH₃ | CH₃ | CH₃ | CH₃ | WO |
| | | | | | 95/18789 |
| V-5 | NHCH₃ | CH₃ | 4-F—C₆H₄ | CH₃ | WO |
| | | | | | 95/18789 |
| V-6 | NHCH₃ | CH₃ | 4-Cl—C₆H₄ | CH₃ | WO |
| | | | | | 95/18789 |
| V-7 | NHCH₃ | CH₃ | 2,4-C₆H₃ | CH₃ | WO |
| | | | | | 95/18789 |
| V-8 | NHCH₃ | Cl | 4-F—C₆H₄ | CH₃ | WO |
| | | | | | 98/38857 |
| V-9 | NHCH₃ | Cl | 4-Cl—C₆H₄ | CH₂CH₃ | WO |
| | | | | | 98/38857 |
| V-10 | NHCH₃ | CH₃ | CH₂C(═CH₂)CH₃ | CH₃ | WO |
| | | | | | 97/05103 |
| V-11 | NHCH₃ | CH₃ | CH═C(CH₃)₂ | CH₃ | WO |
| | | | | | 97/05103 |
| V-12 | NHCH₃ | CH₃ | CH═C(CH₃)₂ | CH₂CH₃ | WO |
| | | | | | 97/05103 |
| V-13 | NHCH₃ | CH₃ | CH═C(CH₃)CH₂CH₃ | CH₃ | WO |
| | | | | | 97/05103 |
| V-14 | NHCH₃ | CH₃ | O—CH(CH₃)₂ | CH₃ | WO |
| | | | | | 97/06133 |
| V-15 | NHCH₃ | CH₃ | O—CH₂CH(CH₃)₂ | CH₃ | WO |
| | | | | | 97/06133 |
| V-16 | NHCH₃ | CH₃ | C(CH₃)═NOCH₃ | CH₃ | WO |
| | | | | | 97/15552 |

TABLE VI

| | |
|---|---|
| | VII |
| 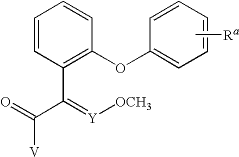 | |

| No. | V | Y | R^{a} | Reference |
|---|---|---|---|---|
| VI-1 | NHCH₃ | N | H | EP-A 398 692 |
| VI-2 | NHCH₃ | N | 3-CH₃ | EP-A 398 692 |
| VI-3 | NHCH₃ | N | 2-NO₂ | EP-A 398 692 |
| VI-4 | NHCH₃ | N | 4-NO₂ | EP-A 398 692 |
| VI-5 | NHCH₃ | N | 4-Cl | EP-A 398 692 |
| VI-6 | NHCH₃ | N | 4-Br | EP-A 398 692 |

TABLE VII

| | |
|---|---|
| | VIII |
| 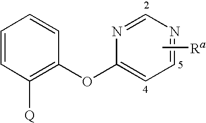 | |

| No. | Q | R^{a} | Reference |
|---|---|---|---|
| VII-1 | C(═CH—OCH₃)COOCH₃ | 5-O- | EP-A 382 375 |
| | | (2-CN—C₆H₄) | |
| VII-2 | C(═CH—OCH₃)COOCH₃ | 5-O- | EP-A 382 375 |
| | | (2-Cl—C₆H₄) | |
| VII-3 | C(═CH—OCH₃)COOCH₃ | 5-O-(2- | EP-A 382 375 |
| | | CH₃—C₆H₄) | |
| VII-4 | C(═N—OCH₃)CONHCH₃ | 5-O- | GB-A 2253624 |
| | | (2-Cl—C₆H₄) | |
| VII-5 | C(═N—OCH₃)CONHCH₃ | 5-O-(2,4- | GB-A 2253624 |
| | | Cl₂—C₆H₃) | |
| VII-6 | C(═N—OCH₃)CONHCH₃₃ | 5-O-(2- | GB-A 2253624 |
| | | CH₃—C₆H₄) | |
| VII-7 | C(═N—OCH₃)CONHCH₃ | 5-O-(2-CH₃, | GB-A 2253624 |
| | | 3-Cl—C₆H₃) | |
| VII-8 | C(═N—OCH₃)CONHCH₃ | 4-F, 5-O-(2- | WO 98/21189 |
| | | CH₃—C₆H₄) | |
| VII-9 | C(═N—OCH₃)CONHCH₃ | 4-F, 5-O- | WO 98/21189 |
| | | (2-Cl—C₆H₄) | |
| VII-10 | C(═N—OCH₃)CONHCH₃ | 4-F, 5-O-(2- | WO 98/21189 |
| | | CH₃, | |
| | | 3-Cl—C₆H₃) | |
| VII-11 | Q1 | 4-F, 5-O- | WO 97/27189 |
| | | (2-Cl—C₆H₄) | |
| VII-12 | Q1 | 4-F, 5-O- | WO 97/27189 |
| | | (2-CH₃, | |
| | | 3-Cl—C₆H₃) | |
| VII-13 | Q1 | 4-F, 5-O-(2,4- | WO 97/27189 |
| | | Cl₂—C₆H₃) | |

Preferred for the use according to the invention are the commercially available active strobilurin compounds. Particular preference is given to the following active compounds: compound I-5 (pyraclostrobin), II-1 (kresoxim-methyl), II-3 (dimoxystrobin), II-11 (ZJ 0712), III-3 (picoxystrobin), IVES (trifloxystrobin), IV-9 (enestroburin), V-16 (orysastrobin), VI-1 (metominostrobin), VII-1 (azoxystrobin) and VII-11 (fluoxastrobin). A further compound of formula I that is useful is fluacrypyrim (methyl(E)-2-{α-[2-isopropoxy-6-(trifluoromethyl)pyrimidin-4-yloxy]-o-tolyl}-3-methoxyacrylate).

In the context of the present invention, the term “compounds of formula I” refers both to the neutral compounds of formula I and to the other active strobilurin compounds mentioned at the outset, and also to salts thereof.

The compounds used according to the present invention, particularly the compounds of formula I, are preferably employed in an application rate of from 25 to 1000 g/ha, particular preferably from 50 to 500 g/ha and in particular from 50 to 250 g/ha.

The compositions according to the invention may also be present together with other active compounds, for example with herbicides, insecticides, growth regulators, fungicides or else with fertilizers. When the compounds used according to the present invention, in particular the compounds (I), or the compositions comprising them, are combined with one or more further active compounds, in particular fungicides, it is in many cases possible, for example, to broaden the activity spectrum or to prevent the development of resistance. In many cases, synergistic effects are obtained.

The following lists of fungicides, insecticides, growth retardants and primers which can be used together with the active compound that inhibits the mitochondrial breathing chain at the level of the b/c₁ complex, in particular with the active strobilurin compound, is meant to illustrate, but not to limit, possible combinations:

### Strobilurins

azoxystrobin, dimoxystrobin, enestroburin, fluoxastrobin, kresoxim-methyl, metominostrobin, picoxystrobin, pyraclostrobin, trifloxystrobin, orysastrobin, methyl (2-chloro-5-[1-(3-methylbenzyloxylmino)ethyl]benzyl)carbamate, methyl (2-chloro-5-[1-(6-methylpyridin-2-ylmethoxyimino)ethyl]benzyl)carbamate, methyl 2-(ortho-((2,5-dimethylphenyloxymethylene) phenyl)-3-methoxyacrylate, 2-(2-(6-(3-chloro-2-methyl-phenoxy)-5-fluoro-pyrimidin-4-yloxy)-phenyl)-2-methoxyimino-N-methyl-acetamide; 3-M ethoxy-2-(2-(N-(4-methoxy-phenyl)-cyclopropane-carboximidoylsulfanylmethyl)-phenyl)-acrylic acid methyl ester;

### Carboxamides

carboxanilides: benalaxyl, benalaxyl-M, benodanil, bixafen, boscalid, carboxin, mepronil, fenfuram, fenhexamid, flutolanil, furametpyr, metalaxyl, ofurace, oxadixyl, oxycarboxin, penthiopyrad, thifluzamide, tiadinil, 2-amino-4-methyl-thiazole-5-carboxylic acid anilide, 2-chloro-N-(1,1,3-trimethyl-indan-4-yl)-nicotinamide, N-(4′-bromobiphenyl-2-yl)-4-difluoromethyl-2-methylthiazole-5-carboxamide, N-(4′-trifluoromethylbiphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide, N-(3′,4′-dichloro-4-fluoro-biphenyl-2-yl)-3-difluoromethyl-1-methylpyrazole-4-carboxamide, N′-(3′,4′-dichloro-5-fluorobiphenyl-2-yl)-3-difluoromethyl-1-methylpyrazole-4-carboxamide, N-(2-cyanophenyl)-3,4-dichloroisothiazole-5-carboxamide, N-(2-(1,3-dimethyl-butyl)-phenyl)-1,3,3-trimethyl-5-fluoro-1H-pyrazole-4-carboxylic acid amide, N-(4′-chloro-3′,5-difluoro-biphenyl-2-yl)-3-difluoromethyl-1-methyl-1H-pyrazole-4-carboxylic acid amide, N-(4′-chloro-3′,5-difluoro-biphenyl-2-yl)-3-trifluoromethyl-1-methyl-1H-pyrazole-4-carboxylic acid amide, N-(3′,4′-dichloro-5-fluoro-biphenyl-2-yl)-3-trifluoromethyl-1-methyl-1H-pyrazole-4-carboxylic acid amide, N-(3′,5-difluoro-4′-methyl-biphenyl-2-yl)-3-difluoromethyl-1-methyl-1H-pyrazole-4-carboxylic acid amide, N-(3′,5-difluoro-4′-methyl-biphenyl-2-yl)-3-trifluoromethyl-1-methyl-1H-pyrazole-4-carboxylic acid amide, N-(cis-2-bicyclopropyl-2-yl-phenyl)-3-difluoromethyl-1-methyl-1H-pyrazole-4-carboxylic acid amide, N-(trans-2-bicyclopropyl-2-yl-phenyl)-3-difluoromethyl-1-methyl-1H-pyrazole-4-carboxylic acid amide;
carboxylic acid morpholides: dimethomorph, flumorph;
benzamides: flumetover, fluopicolide (picobenzamid), fluopyram, zoxamide, N-(3-Ethyl-3,5-5-trimethyl-cyclohexyl)-3-formylamino-2-hydroxy-benzamide;
other carboxamides: carpropamid, diclocymet, mandipropamid, oxytetracyclin, silthiofam, N-(6-methoxy-pyridin-3-yl)cyclopropanecarboxylic acid amide, N-(2-(4-[3-(4-chlorophenyl)prop-2-ynyloxy]-3-methoxyphenyl)ethyl)-2-methanesulfonylamino-3-methyl butyramide, N-(2-(4-[3-(4-chlorophenyl)prop-2-ynyloxy]-3-methoxyphenyl)-ethyl)-2-ethanesulfonylamino-3-methylbutyramide;

### Azoles

triazoles: azaconazole, bitertanol, bromuconazole, cyproconazole, difenoconazole, diniconazole, diniconazole-M, enilconazole, epoxiconazole, fenbuconazole, flusilazole, fluquinconazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimenol, triadimefon, triticonazole, uniconazole, 1-(4-chloro-phenyl)-2-([1,2,4]triazol-1-yl)-cycloheptanole;
imidazoles: cyazofamid, imazalil, imazail-sulfphat, pefurazoate, prochloraz, triflumizole;
benzimidazoles: benomyl, carbendazim, fuberidazole, thiabendazole;
others: ethaboxam, etridiazole, hymexazole;

### Nitrogenous Heterocyclyl Compounds

pyridines: fluazinam, pyrifenox, 3-[5-(4-chlorophenyl)-2,3-dimethylisoxazolidin-3-yl]pyridine, 2,3,5,6-tetrachloro-4-methanesulfonyl-pyridine, 3,4,5-trichloro-pyridine-2,6-dicarbonitrile, N-(1-(5-Bromo-3-chloro-pyridin-2-yl)-ethyl)-2,4-dichloro-nicotinamide, N-((5-bromo-3-chloro-pyridin-2-yl)-methyl)-2,4-dichloro-nicotinamide;
pyrimidines: bupirimate, cyprodinil, diflumetorim, ferimzone, fenarimol, mepanipyrim, nitrapyrin, nuarimol, pyrimethanil;
piperazines: triforine;
pyrroles: fludioxonil, fenpiclonil;
morpholines: aldimorph, dodemorph, dodemorph-acetate, fenpropimorph, tridemorph;
dicarboximides: iprodione, fluoroimid, procymidone, vinclozolin;
others: acibenzolar-S-methyl, anilazine, blasticidin-S, captan, chinomethionat, captafol, dazomet, debacarb, diclomezine, difenzoquat, difenzoquat-methylsulphat, fenoxanil, folpet, oxolinic acid, piperalin, fenpropidin, famoxadone, fenamidone, octhilinone, probenazole, proquinazid, pyroquilon, quinoxyfen, tricyclazole, 5-chloro-7-(4-methylpiperidin-1-yl)-6-(2,4,6-trifluorophenyl)-[1,2,4]triazolo[1,5-a]pyrimidine, 2-butoxy-6-iodo-3-propylchromen-4-one, N,N-dimethyl-3-(3-bromo-6-fluoro-2-methylindole-1-sulfonyl)-[1,2,4]triazole-1-sulfonamide;

### Carbamates and Dithiocarbamates

dithiocarbamates: ferbam, mancozeb, maneb, metiram, metam, methasulphocarb, propineb, thiram, zineb, ziram;
carbamates: diethofencarb, benthiavalicarb, flubenthiavalicarb, iprovalicarb, propamocarb, propamocarb hydrochlorid, methyl 3-(4-chlorophenyl)-3-(2-isopropoxycarbonylamino-3-methylbutyrylamino)propionate, 4-fluorophenyl N-(1-(1-(4-cyanophenyl)ethanesulfonyl)but-2-yl)carbamate;

### Other Fungicides

guanidines: dodine, dodine free base, guazatine, guazatine-acetate, iminoctadine, iminoctadine-triacetate, iminoctadine-tris(albesilate);
antibiotics: kasugamycin, kasugamycin-hydrochlorid-hydrat, polyoxins, strepto-mycin, validamycin A;
organometal compounds: fentin salts (e.g. fentin acetate, fentin chloride, fentin hydroxide);
sulfur-containing heterocyclyl compounds: isoprothiolane, dithianon;
organophosphorus compounds: edifenphos, fosetyl, fosetyl-aluminum, iprobenfos, pyrazophos, tolclofos-methyl, phosphorous acid and its salts;
organochlorine compounds: thiophanate methyl, chlorothalonil, dichlofluanid, dichlorophene, flusulfamide, phthalide, hexachlorobenzene, pencycuron, pentachlorophenol and salts thereof, quintozene, tolyifluanid, N-(4-chloro-2-nitro-phenyl)-N-ethyl-4-methyl-benzenesulfonamide;
nitrophenyl derivatives: binapacryl, dicloran, dinocap, dinobuton, nitrothal-isopropyl, tecnazen;
inorganic active compounds: Bordeaux mixture, copper salts (e.g. copper acetate, copper hydroxide, copper oxychloride, basic copper sulfate), sulfur;
others: biphenyl, bronopol, cyflufenamid, cymoxanil, diphenylamine, metrafenone, mildiomycine, oxine-copper, prohexadione-calcium, spiroxamine, tolylfluanid, N-(cyclopropylmethoxyimino-(6-difluoromethoxy-2,3-difluoro-phenyl)-methyl)-2-phenylacetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluormethyl-4-(3-trimethylsilanyl-propoxy)-phenyl)-N-ethyl-N-methyl formamidine, N′-(5-difluormethyl-2-methyl-4-(3-trimethylsilanyl-propoxy)-phenyl)-N-ethyl-N-methyl formamidine;

Plant growth regulators (PGRs): auxins (e.g. β-indoleacetic acid (IAA), 4-indol-3-ylbutyric acid (IBA), 2-(1-naphthyl)acetamide (NAA)), cytokinins, gibberellins, ethylene, abscisic acid.

Growth retardants: prohexadione and its salts, trinexapac-ethyl, chlormequat, mepiquat-chloride, diflufenzopyr.

Primers: benzothiadiazole (BTH), salicylic acid and its derivates, β-aminobutyric acid (BABA), 1-methylcyclopropene (1-MCP), lipopolysaccharides (LPS), neonicotinoides (e.g. acetamiprid, clothianidin, dinetofuran, fipronil, imidacloprid, thiacloprid, thiamethoxam).

Ethylene modulators: ethylene biosynthesis inhibitors, which inhibit the conversion of S-adenosyl-L-methionine into 1-aminocyclopropane-1-carboxylic acid (ACC), such as derivatives of vinylglycine, hydroxylamines, oxime ether derivatives; ethylene biosynthesis inhibitors which block the conversion of ACC into ethylene, selected from the group consisting of: Co++ or Ni++ ions in plant-available forms; phenolic radical scavengers such as n-propyl gallate; polyamines, such as putrescine, spermine or spermidine; structural analogs of ACC, such as α-aminoisobutyric acid or L-aminocyclopropene-1-carboxylic acid; salicylic acid or acibenzolar-5-methyl; structural analogs of ascorbic acid which act as inhibitors of ACC oxidase, such as prohexadione-Ca or trinexapac-ethyl; and triazolyl compounds such as paclobutrazol or uniconazole as inhibitors of cytochrome P-450-dependent monooxygenases, whose main action is to block the biosynthesis of gibberellins;

inhibitors of the action of ethylene selected from the group consisting of: structural analogs of ethylene such as 1-methylcyclopropene or 2,5-norbornadiene and 3-amino-1,2,4-triazole or Ag++ ions

The active compounds mentioned above are generally known and commercially available.

In a preferred embodiment, the compounds that inhibit the mitochondrial breathing chain at the level of the b/c₁ complex, in particular the strobilurin compounds, specifically the compounds of formula I, are used according to the invention in combination with bioregulators, in particular with primers.

In a preferred embodiment, the compounds that inhibit the mitochondrial breathing chain at the level of the b/c₁ complex, in particular the strobilurin compounds, specifically the compounds of formula I, are used according to the invention in combination with prohexadione-Ca, and/or with trinexapac-ethyl and/or with a conventional cryoprotectant as auxiliary.

In a further preferred embodiment, the compounds that inhibit the mitochondrial breathing chain at the level of the b/c₁ complex, in particular the strobilurin compounds, specifically the compounds of formula I, are used according to the invention in combination with vitamin E or a derivative thereof and/or with abscisic acid and/or with a conventional cryoprotectant as auxiliary.

The weight ratio of compounds that inhibit the mitochondrial breathing chain at the level of the b/c₁ complex, in particular the strobilurin compounds, specifically the compounds of formula I, to vitamin E or its derivatives is preferably 1:1 to 1:20, especially preferably 1:5 to 1:20 and in particular 1:5 to 1:15. The weight ratio of the compounds used according to the invention, specifically the compounds of formula I, to abscisic acid is preferably 1:0.05 to 1:1, especially preferably 1:0.05 to 1:0.5 and in particular 1:0.1 to 1:0.3. The weight ratio of the compounds used according to the invention, specifically the compounds of formula I, to the cryoprotectant is preferably 1:10 to 1:1000, especially preferably 1:10 to 1:500 and in particular 1:10 to 1:100.

In the context of the present invention, vitamin E is understood as meaning all compounds of the vitamin E group, for example the α- to η-tocopherols and the tocotrienols and their isomers, salts and esters, it being irrelevant whether these compounds are of natural or synthetic origin. Substances, which are particularly preferably used, are α-tocopherol, which occurs naturally (RRR-α-tocopherol) or an ester thereof with a C₁-C₄-carboxylic acid, such as formic acid, acetic acid, propionic acid or butyric acid. α-Tocopherol acetate is used in particular.

Abscisic acid is (S)(+)-5-(1-hydroxy-2,6,6-trimethyl-4-oxo-2-cyclohexenyl)-3-methyl-cis/trans-2,4-pentadienoic acid.

Cryoprotectants which are suitable for the treatment of plants encompass, for example, alcohols such as propanol and butanol, polyols such as glycol or glycerol, (poly)ether polyols such as diethylene glycol, triethylene glycol and polyethylene glycols with a molecular weight of up to 500 and salts of formic acid, such as, in particular, sodium, potassium, ammonium, calcium and magnesium salts of formic acid. A cryoprotectant, which is preferably used, is glycerol. Also preferred is the use of one or more salts of formic acid.

In plant physiology, primers are compounds known for priming activity. Priming is known as a process, which finally results in enhanced capability of plants to cope with both biotic (e.g. fungal pathogens) and abiotic (e.g. drought) stress. Since primers interact in a complex manner with signaling in plants, in general they can be classified as a subgroup of bioregulators (Reviewed in Conrath et al. (2006) Priming: Getting ready for battle. Molecular Plant-Microbe Interactions 19: 1062-1071).

Ethylene modulators are to be understood as meaning substances, which block the natural formation of the plant hormone ethylene or else its action. [Reviews for example in M. Lieberman (1979), Biosynthesis and action of ethylene, Annual Review of Plant Physiology 30: 533-591; S. F. Yang and N. E. Hoffman (1984), Ethylene biosynthesis and its regulation in higher plants, Annual Review of Plant Physiology 35: 155-189; E. S. Sisler et. al. (2003), 1-substituted cyclopropenes: Effective blocking agents for ethylene action in plants, Plant Growth Regulation 40: 223-228; WO2005044002].

The compounds used according to the invention, specifically the compounds of formula I, or their combination with the abovementioned auxiliaries, are typically employed as formulations as they are conventionally used in the field of crop protection.

For example, they can be diluted with water in the form of concentrated solutions, suspensions or emulsions and applied by spraying. The use forms depend on the type of plant or the plant part to which it is to be applied; in any case, they should allow as fine as possible a distribution of the active compounds and auxiliaries.

In addition to the compounds used according to the invention, specifically the compounds of formula I, if appropriate as a combination with vitamin E and/or abscisic acid and/or the cryoprotectant, the formulations may comprise formulation auxiliaries as are conventionally used for the formulation of crop protection products, for example inert auxiliaries and/or surface-active substances such as emulsifiers, dispersants, wetters and the like.

Suitable surface-active substances are the alkali metal, alkaline earth metal and ammonium salts of aromatic sulfonic acids, for example lignosulfonic acid, phenol-sulfonic acid, naphthalenesulfonic acid and dibutylnaphthalenesulfonic acid and of fatty acids, alkyl- and alkylarylsulfonates, alkyl, lauryl ether and fatty alcohol sulfates, and the salts of sulfated hexa-, hepta- and octadecanols and of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenyl polyglycol ethers, tributylphenyl polyglycol ether, alkylaryl polyether alcohols, isotridecyl alcohol, fatty alcohol/ethylene oxide condensates, ethoxylated castor oil, polyoxyethylene or polyoxypropylene alkyl ethers, lauryl alcohol polyglycol ether acetate, sorbitol esters, lignosulfite waste liquors, methylcellulose or siloxanes. Examples of suitable siloxanes are polyether/polymethylsiloxane copolymers, which are also referred to as spreaders or penetrants.

### Inert Formulation Auxiliaries are Essentially:

mineral oil fractions of medium to high boiling point such as kerosene and diesel oil, furthermore coal tar oils and oils of vegetable or animal origin, aliphatic, cyclic and aromatic hydrocarbons, for example paraffins, tetrahydronaphthalene, alkylated naphthalenes and their derivatives, alkylated benzenes and their derivatives, alcohols such as methanol, ethanol, propanol, butanol and cyclohexanol, ketones such as cyclohexanone, strongly polar solvents, for example amines such as N-methyl-pyrrolidone, and water.

Aqueous use forms of the compounds used according to the invention, specifically the compounds I, or their combination with vitamin E and/or abscisic acid and/or the cryoprotectant can be prepared from storage formulations such as emulsion concentrates, suspensions, pastes, wettable powders or water-dispersible granules by addition of water. To prepare emulsions, pastes or oil dispersions, the compounds used according to the present invention, in particular the compounds of formula I, or their abovementioned combination with vitamin E and/or abscisic acid and/or the cryoprotectant, as such or dissolved in an oil or solvent, can be homogenized in water by means of wetting agent, sticker, dispersant or emulsifier. Naturally, the use forms will comprise the auxiliaries used in the storage formulations.

In a preferred embodiment, the compounds used according to the invention, specifically the compounds of formula I, or their abovementioned combination are used in the form of an aqueous spray mixture. The aqueous spray mixture comprises the respective compound in an amount of preferably from 50 to 200 ppm. When the abovementioned combination is used as spray mixture, it will comprise vitamin E in an amount of preferably from 50 to 4000 ppm, especially preferably from 500 to 3500 ppm and in particular from 1 000 to 3000 ppm; abscisic acid in an amount of preferably from 0 to 200 ppm, especially preferably of from 2.5 to 100 ppm and in particular of from 5 to 15 ppm, and the cryoprotectant in an amount of preferably from 0 to 50000 ppm, especially preferably from 500 to 20000 ppm, and in particular from 500 to 10000 ppm.

The components used according to the invention, specifically the active strobilurin compound, further active compound and/or the cryoprotectant can be applied to the plant or the plant parts as a mixture or separately; in the latter case, the individual components should be applied within as short an interval as possible.

The active compounds, particularly the strobilurins, which are used in accordance with the invention, can be employed for application in all of the abovementioned plants, but also in plant species, which differ from them. Depending on the plant part to which they are to be applied, they can be applied with apparatuses which are known per se and conventionally used in agricultural practice, application in the form of an aqueous spray solution or spray mixture being preferred.

The inventive method is suitable for foliar application in living crops of plants, for soil applications prior to sowing or planting, including overall soil treatment and furrow applications providing protection of the early stages of corn, wheat, soybean, cotton and other crops against chilling stress.

Application is effected by spraying to run-off point or by seed dressing. Either all of the aerial plant part or else only individual plant parts, such as flowers, leaves or fruits, are treated. The choice of the individual plant parts to be treated depends on the species of the plant and its developmental stage. Later stages may be protected preferably by leaf treatments. In one embodiment the application is onto seed. It is preferred to treat the embryos, seedlings, buds and flowers in various developmental stages, and the young fruits.

Application is preferably effected prior to a period of chilling temperature or frost. It is preferably effected at least 12 hours, especially preferably at least 24 hours and in particular 36 hours to 20 days before the expected onset of chilling temperatures or frost.

For treating seeds, in general the active compound is employed in amounts of from 1 to 1000 g/100 kg, preferably from 5 to 100 g/00 kg, of seed.

The present invention furthermore relates to a method for improving the tolerance of plants to low temperatures, preferably for reducing or preventing chilling injury and frost damage in plants, which comprises applying an aqueous composition comprising a compound used according to the invention, specifically a compound of formula I, to seed, plants or plant parts.

What has been said above with regard to the compounds used according to the invention, specifically the compounds of formula I, other components, the aqueous composition and the application, applies here analogously.

The tolerance of plants to chilling temperatures and frost is increased markedly by the use according to the invention of the active strobilurin compounds. In particular, chilling injury and frost damage on plants are prevented or at least reduced by the use according to the invention. A further advantage of the use according to the invention of the compound that inhibits the mitochondrial breathing chain at the level of the b/c₁ complex, particularly the active strobilurin compounds, such as kresoxim-methyl, pyraclostrobin and orysastrobin, especially pyraclostrobin and orysastrobin, preferably kresoxim-methyl and orysastrobin, in particular orysastrobin, is their activity against fireblight. Accordingly, the plants treated in accordance with the invention are not only more resistant to low temperatures, but are additionally protected against this floral infection.

The protecting effect of treatments against chilling stress was not only measured quantitatively in controlled environment (e.g. pear, corn, Arabidopsis, wheat), but also observed for other crops both under practical field conditions (e.g. sugar beets, oranges), indicating that the broad applicability of the principle.

The examples that follow are intended to illustrate the invention, but without imposing any limitation.

### EXAMPLE 1

### 1.1 Experiment

Arabidopsis thaliana plants were grown in pots (8 cm diameter) under controlled environmental conditions at 21° C. during the day and at 19° C. during the night, under a light regiment of 9 h light and 15 h dark per day.

Chemical treatment was done 18 days after sowing. Each pot was treated with 500 μl of spray solution according to the treatment schedule below with a commercial pump spray applicator.

### 1) Untreated

2) Orysastrobin (250 ppm)
3) Orysastrobin (500 ppm)
4) Pyraclostrobin (500 ppm)

After chemical treatment, the pots have been transferred to the same growth conditions for three days. Then the pots were transferred to three different environmental conditions to exert cold stress:

Control plants (A) were kept under the same conditions as described above.

Stressed plants (B) were transferred for 2 days to 6° C. under a 9-15 h day-night cycle. This cold treatment allows Arabidopsis plants to acclimate to a certain extent to the following freezing stress (−4° C., 24 h in the dark) (Wanner et al., 1999, Cold-induced freezing tolerance in Arabidopsis, Plant Physiology 120, 391-399).

Stressed plants (C) were not cold-hardened and kept for another 2 days under control environment before being transferred for one day to −4° C. without light.

After these treatments, all pots were returned to standard growth conditions (controlled environmental conditions) as described above.

| | Chemical | 21° C./19° C. | 6° C. | −4° C. |
|---|---|---|---|---|
| Stress condition | treatment | (9/15 h) | (9/15 h) | 24 h dark |
| A | 18 days after | 6 days | — | — |
| (control plants) | sowing, if any | | | |
| B | 18 days after | 3 days | 2 days | 1 day |
| | sowing | | | |
| C | 18 days after | 5 days | — | 1 day |
| | sowing | | | |

### 1.2 Results

3 days and 9 days after chemical treatment (3 days after recovery from freezing treatment) the trial was evaluated by visual assessment, scoring the symptoms in % leaf damage.

Three days after chemical treatment there was no leaf damage detectable. After the stress treatment the following leaf damage was assessed:

| | No chemical | Orysastrobin | Orysastrobin | Pyraclostrobin |
|---|---|---|---|---|
| Stress | treatment | 250 ppm | 500 ppm | 500 ppm |
| condition | (1) | (2) | (3) | (4) |
| A | 0% | 0% | 0% | 0% |
| (control | | | | |
| plants) | | | | |
| B | 30% | 0% | 0% | 0% |
| C | 80% | 5% | 10% | 30% |

The environmental conditions chosen were sufficient to induce strong leaf damage. As expected, a period of 2 days cold hardening the stress condition “B” was able to reduce stress symptoms. However, as can be seen from the results, the most effective reduction of the stress symptoms was achieved by the inventive chemical treatments. Both chemical treatments, orysastrobin and pyraclostrobin, were highly effective to reduce cold stress symptoms in Arabidopsis plants under different stress conditions.

### EXAMPLE 2

### 2.1 Experiment

A single limb on a mature Bosc pear tree at the full bloom developmental stage was sprayed to runoff with Pristine® 38WG at the rate of 1.03 grams per two liters, equivalent to 14.5 oz per acre at 200 gal per acre (Pristine® 38WG is a commercial formulation of pyraclostrobin and boscalid manufactured by BASF Aktiengesellschaft). Silgard® 309 (a commercially available adjuvant) was added to the Pristine® and used at the rate of 0.297 ml per two liters, equivalent to 2.0 oz per 100 gal or 4.0 oz per acre. The Pristine® plus Silgard® spray was applied, wherein a single control limb on a nearby tree was left unsprayed.

After one day, a controlled-temperature limb cage, which encloses a 2-meter length of scaffold limb, was used to reduce the temperature from an ambient temperature of 3.9° C. to −3.7° C. The time required to reach this temperature was approximately 10 minutes. The temperature was increased slightly and held between −3.3° C. and −2.8° C. for 5 minutes.

Blossoms were evaluated for frost injury five days later. Total flowers on each limb that were inside the cage were counted. A flower was considered injured if discoloration was visible at the base of the pistils in the floral cup.

### 2.2 Results

Control limb: total of 283 blossoms

202 (71%) healthy and 81 (29%) injured

Limb treated according to the present invention: total of 163 blossoms 147 (90%) healthy and 16 (10%) injured

Thus, Pristine® applied before the low temperature treatment gave a substantial degree of frost protection to the pear blossoms.

### EXAMPLE 3

### 3.1 Experiment

Corn seeds (Zea mays; variety Pioneer herbicide resistant 33P71) were treated using either:

T1: Water (untreated)
T2: Pyraclostrobin (5 g active ingredient 100 kg seeds)
T3. Azoxystrobin (1 g active ingredient/100 kg seeds)

Subsequently, the treated seeds were planted in plastic pots (6 cm×6 cm×7 cm) filled with sand (metro mix). Seeds were incubated in a growth chamber (Conviron) at 25° C. and 60% humidity under a dark/light cycle of 16/8 h for 5 days (seedlings were at code 10). At this point, seedlings were exposed to a temperature of −5° C. for 3 hours. Following cold stress, the viable seedlings were kept growing until they had reached code 13. At this stage, they were submitted to additional 2 hours of cold stress at −5° C. Finally, the number of damaged seedlings (%) for each seed treatment was recorded.

### 3.2 Results

| | T1 | T2 | T3 |
|---|---|---|---|
| | (Water) | (Pyraclostrobin) | (Azoxystrobin) |
| Second exposure to | 80% | 0% | 38% |
| cold stress | | | |

The environmental conditions chosen were sufficient to induce strong leaf damage. As can be seen from the results, the treatment of seeds with the inventive chemicals of formula I results in an effective reduction of stress symptoms under cold stress while control plants treated with water only were severely harmed.

### EXAMPLE 4

Adult Citrus trees (Citrus sinensis) were treated by three 1600 g/ha pyraclostrobin leaf applications at 14 to 18 day intervals. Applications began shortly before the initial freeze in winter seasons. Temperatures dropped to −6° C. in three separate cold weather events. With extreme low temperatures, nothing is expected to reduce damage. However, even under these extreme conditions the plants growing on the pyraclostrobin treated plot exhibited less leaf burn symptoms and fruit drop than the untreated control plants. The results of this experiment show a strong chilling protection of pyraclostrobin in citrus.

1. Use of an active compound that inhibits the mitochondrial breathing chain at the level of the b/c₁ complex for improving the tolerance of plants to low temperatures.

2. The use according to claim 1, wherein the active compound is a strobilurin or a salt thereof.

3. The use according to claim 2, wherein the strobilurin is a compound of formula I 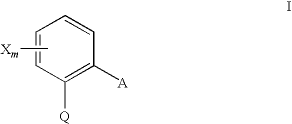
in which the variables are as defined below:
X is halogen, C₁-C₄-alkyl or trifluoromethyl;
m is 0 or 1;
Q is C(═CH—CH₃)—COOCH₃, C(═CH—OCH₃)—COOH₃, C(═N—OCH₃)—CONHCH₃, C(═N—OCH₃)—COOCH₃, N(—OCH₃)—COOCH₃, or the group Q1 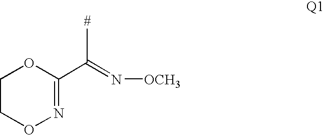
where # denotes the bond to the phenyl ring;
A is —O—B, —CH₂O—B, —OCH₂—B, —CH₂S—B, —CH═CH—B, —C≡C—B, —CH₂O—N═C(R¹)—B, —CH₂S—N═C(R¹)—B, —CH₂O—N═C(R¹)—CH═CH—B, or —CH₂O—N═C(R¹)—C(R²)═N—OR³, where
B is phenyl, naphthyl, 5- or 6-membered heteroaryl or 5- or 6-membered heterocyclyl which contains one, two or three nitrogen atoms and/or one oxygen or sulfur atom or one or two oxygen and/or sulfur atoms, where the ring systems are unsubstituted or substituted by one, two or three groups R^{a}:
R^{a} independently of one another are cyano, nitro, amino, aminocarbonyl, aminothiocarbonyl, halogen, C₁-C₆-alkyl, C₁-C₆-haloalkyl, C₁-C₆-alkylcarbonyl, C₁-C₆-alkylsulfonyl, C₁-C₆-alkylsulfinyl, C₃-C₆-cycloalkyl, C₁-C₆-alkoxy, C₁-C₆-haloalkoxy, C₁-C₆-alkyloxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₂-C₆-alkylaminothiocarbonyl, di-C₁-C₆-alkylaminothiocarbonyl, C₂-C₆-alkenyl, C₂-C₆-alkenyloxy, phenyl, phenoxy, benzyl, benzyloxy, 5- or 6-membered heterocyclyl, 5- or 6-membered heteroaryl, 5- or 6-membered heteroaryloxy, C(═NOR^{a})—R^{b} or OC(R^{a})₂—C(R^{b})═NOR^{b}, where the cyclic groups for their part may be unsubstituted or substituted by one, two, three, four or five groups R^{b}:
R^{b} independently of one another are cyano, nitro, halogen, amino, aminocarbonyl, aminothiocarbonyl, C₁-C₆-alkyl, C₁-C₆-haloalkyl, C₁-C₆-alkylsulfonyl, C₁-C₆-alkylsulfinyl, C₃-C₆-cycloalkyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino, C₁-C₆-alkylaminocarbonyl, di-C₁-C₆-alkylamino-carbonyl, C₁-C₆-alkylaminothiocarbonyl, di-C₁-C₆-alkylaminothiocarbonyl, C₂-C₆-alkenyl, C₂-C₆-alkenyloxy, C₃-C₆-cycloalkyl, C₃-C₆-cycloalkenyl, phenyl, phenoxy, phenylthio, benzyl, benzyloxy, 5- or 6-membered heterocyclyl, 5- or 6-membered heteroaryl, 5- or 6-membered heteroaryl-oxy or C(═NOR^{A})—R^{B},
R^{A}, R^{B} independently of one another are hydrogen or C₁-C₆-alkyl;
R¹ is hydrogen, cyano, C₁-C₄-alkyl, C₁-C₄-haloalkyl, C₃-C₆-cycloalkyl, C₁-C₄-alkoxy, or C₁-C₄-alkylthio;
R² is phenyl, phenylcarbonyl, phenylsulfonyl, 5- or 6-membered heteroaryl, 5- or 6-membered heteroarylcarbonyl or 5- or 6-membered heteroarylsulfonyl, where the ring systems may be unsubstituted or substituted by one, two, three, four or five groups R^{a},
C₁-C₁₀-alkyl, C₃-C₆-cycloalkyl, C₂-C₁₀-alkenyl, C₂-C₁₀-alkynyl, C₁-C₁₀-alkylcarbonyl, C₂-C₁₀-alkenylcarbonyl, C₃-C₁₀-alkynylcarbonyl, C₁-C₁₀-alkylsulfonyl or C(═NOR^{a})—R^{b}, where the carbon chains may be unsubstituted or substituted by one, two, three, four or five groups R^{c}:
R^{c} independently of one another are cyano, nitro, amino, aminocarbonyl, aminothiocarbonyl, halogen, C₁-C₆-alkyl, C₁-C₆-haloalkyl, C₁-C₆-alkylsulfonyl, C₁-C₆-alkylsulfinyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl, C₁-C₆-alkyl-aminothiocarbonyl,
di-C₁-C₆-alkylaminothiocarbonyl, C₂-C₆-alkenyl, C₂-C₆-alkenyloxy,
C₃-C₆-cycloalkyl, C₃-C₆-cycloalkyloxy, 5- or 6-membered heterocyclyl, 5- or 6-membered heterocyclyloxy, benzyl, benzyloxy, phenyl, phenoxy, phenylthio, 5- or 6-membered heteroaryl, 5- or 6-membered heteroaryloxy or heteroarylthio, where the cyclic groups may be partially or fully halogenated or may be substituted by one, two or three groups R^{a}; and
R³ is hydrogen, C₁-C₆-alkyl, C₂-C₆-alkenyl, C₂-C₆-alkynyl, where the carbon chains may be substituted by one, two, three, four or five groups R^{c}; or
a strobilurin compound selected from the group consisting of methyl (2-chloro-5-[1-(3-methylbenzyloxyimino)ethyl]benzyl)carbamate, methyl (2-chloro-5-[1-(6-methylpyridin-2-ylmethoxyimino)ethyl]benzyl)carbamate, 2-(2-(6-(3-chloro-2-methyl-phenoxy)-5-fluoro-pyrimidin-4-yloxy)-phenyl)-2-methoxy-imino-N-methyl-acetamide and 3-methoxy-2-(2-(N-(4-methoxy-phenyl)cyclo-pro-pane-carboximidoyl-sulfanyl-methyl)-phenyl)-acrylic acid methyl ester.

4. The use according to claim 3, wherein the strobilurin is a compound of formula I.

5. The use according to claim 3, wherein the compound of formula I is selected from the group consisting of pyraclostrobin, kresoxim-methyl, dimoxystrobin, ZJ 0712, picoxystrobin, trifloxystrobin, enestroburin, orysastrobin, metominostrobin, azoxystrobin and fluoxastrobin.

6. The use according to claim 3, wherein the compound of
formula I is selected from the group consisting of pyraclostrobin, kresoxim-methyl, dimoxystrobin and orysastrobin.

7. The use according to claim 3, wherein the compound of
formula I is selected from the group consisting of azoxystrobin, pyraclostrobin and orysastrobin.

8. The use according to claim 3, wherein the compound of
formula I is orysastrobin.

9. The use according to claim 1 for reducing or preventing chilling injury in, corn, rice, wheat, barley, sunflower, rapeseed, soybean, sugarbeet, sugarcane, potato, tomato, bell pepper, aubergine, melon, cucumber, bean, pea, banana, vinegrapes (grapes), pome and stone fruit, citrus fruits and coffee.

10. The use according to claim 9 for reducing or preventing chilling injury in corn, rice, soybean, pome and stone fruit, citrus fruits and coffee.

11. The use according to claim 9 for reducing or preventing chilling injury in almond, corn, soybean, citrus fruits and coffee.

12. The use according to claim 1 for reducing or preventing frost damage in, pome and stone fruit, citrus plants, corn, rice, wheat, barley, sunflower, rapeseed, soybean, sugarbeet, sugarcane, potato, tomato, bell pepper, aubergine, melon, cucumber, bean, pea, banana, vinegrapes (grapes) and coffee.

13. The use according to claim 12 for reducing or preventing frost damage, in corn, rice, soybean, pome and stone fruit, citrus fruits and coffee.

14. The use according to claim 13 for reducing or preventing frost damage in, corn, soybean, citrus fruits and coffee.

15. The use according to claim 1 for reducing or preventing frost damage on flowers, young fruits and seedlings.

16. The use according to claim 1 wherein the active compound that inhibits the mitochondrial breathing chain at the level of the b/c₁ complex is used together with a further active compound from the group of fungicides and growth retardants.

17. The use according to claim 1 wherein the active compound that inhibits the mitochondrial breathing chain at the level of the b/c₁ complex is used together with a further active compound selected from the group of compounds with priming activity (primer) and 1-methylcyclopropene (1-MCP).

18. The use according to claim 1 in combination with prohexadione-Ca, and/or with trinexapac-ethyl and/or conventional cryoprotectants.

19. The use according to claim 1 in combination with vitamin E and/or abscisic acid and/or conventional cryoprotectants.

20. The use according to claim 18, wherein the cryoprotectant is selected from glycerol and salts of formic acid.

21. The use according to claim 19, wherein the active compound that inhibits the mitochondrial breathing chain at the level of the b/c₁ complex and vitamin E are employed in a weight ratio of from 1:1 to 1:20.

22. The use according to claim 19, wherein the active compound that inhibits the mitochondrial breathing chain at the level of the b/c, complex and abscisic acid are employed in a weight ratio of from 1:0.05 to 1:1.

23. The use according to claim 18, wherein the active compound that inhibits the mitochondrial breathing chain at the level of the b/c₁ complex and the conventional cryoprotectants are employed in a weight ratio of from 1:10 to 1:500.

24. The use according to claim 1, wherein the active compound that inhibit the mitochondrial breathing chain at the level of the b/c, complex is employed in the form of an aqueous spray liquor comprising said compound in an amount of from 5 to 1000 ppm.

25. The use according to claim 1, wherein the application rate of the active compound that inhibit the mitochondrial breathing chain at the level of the b/c, complex is in the range from 25 to 1000 g/ha.

26. The use according to claim 1, wherein the active compound that inhibit the mitochondrial breathing chain at the level of the b/c₁ complex is applied to seed.

27. A method for improving the tolerance of plants to low temperatures, wherein a composition comprising at least one active compound that inhibits the mitochondrial breathing chain at the level of the b/c₁ complex according to claim 1 is applied to plants or plant parts.

28. The method according to claim 27, wherein the composition is an aqueous composition.
